(19) United States
(12) Patent Application Publication
(10) Pub. No.: US 2008/0041064 A1
(43) Pub. Date: Feb. 21, 2008

(54) Preswirl pollution air handling with tangential on-board injector for turbine rotor cooling

(75) Inventors: Christopher Moore, Newington, CT (US); John P. Virtue, Middletown, CT (US); James P. Chrisikos, Vernon, CT (US)

Correspondence Address: CARLSON, GASKEY & OLDS, P.C., 400 WEST MAPLE ROAD, SUITE 350, BIRMINGHAM, MI, 48009, US

(73) Assignee: United Technologies Corporation

(21) Appl. No.: 11/505,677

(22) Filed: Aug. 17, 2006

(51) Int. Cl. F02C 6/08

(52) U.S. Cl. 60/782; 60/785

(57) ABSTRACT

A gas turbine engine includes a turbine rotor and a compressor, which provides discharge air. A nozzle, typically referred to a tangential on-board injector (TOBI), is arranged near the rotor to deliver the discharge air near the turbine rotor for cooling it. The TOBI receives pollution air leaking past seals within the gas turbine engine. The TOBI swirls the discharge air and the pollution air before it reaches the turbine rotor. The TOBI provides multiple passages separated by vanes. At least some of the passages include discharge inlets and outlets for carrying the discharge air from the compressor to the turbine rotor. Typically, several of the passages are unused and blocked. However, the example arrangement provides a pollution inlet and outlet in at least one of the normally unused, blocked passages. The pollution air flowing through its passage in the TOBI is swirled so that the pollution air that intermingles with the swirled discharge air, while minimizing the reduction in velocity of the discharge air that is used to cool the turbine rotor.

### BACKGROUND OF THE INVENTION

This invention relates to a method and apparatus of handling pollution air within a gas turbine engine. More particularly, the invention relates to swirling the pollution air prior to introducing it to discharge air from the compressor when cooling the turbine rotor.

The limiting factor in most turbine designs is the maximum temperature that can be tolerated at the turbine inlet. To address this problem, inlet vanes of the first stage turbine and rotor blades are cooled typically using compressor bleed air, which is simply referred to as discharge air.

Modern gas turbine engines typically incorporate a preswirl system using a nozzle referred to as a tangential on-board injector (TOBI). Swirling the air reduces the temperature rise associated with injecting cooling air on board the turbine rotor.

Gas turbine engines produce pollution air, which is air that leaks past the various seals within the gas turbine engine to the TOBI. The discharge air swirled by the TOBI is exposed to this pollution air, which has low momentum and undesirably results in a reduction in the swirl velocity of the discharge air. Reducing the swirl velocity increases the cooling air temperature on board the rotor, which requires the TOBI to provide more discharge air. Designing TOBIs to provide larger volumes of discharge air reduces the efficiency of the gas turbine engine.

What is needed is a system and method of handling the pollution air in the area of the TOBI to prevent a decrease in swirl velocity of the discharge air used for cooling the turbine rotor.

### SUMMARY OF THE INVENTION

A gas turbine engine includes a turbine rotor and a compressor, which provides discharge air. A nozzle, typically referred to a tangential on-board injector (TOBI), is arranged near the rotor to deliver the discharge air on board the turbine rotor for cooling it. The TOBI receives pollution air leaking past seals within the gas turbine engine. The TOBI swirls the discharge air and the pollution air before it reaches the turbine rotor.

The TOBI provides multiple passages separated by vanes. At least some of the passages include discharge inlets and outlets for carrying the discharge air from the compressor to the turbine rotor. Typically, several of the passages are unused and blocked. However, the example arrangement provides a pollution inlet and outlet in at least one of the normally unused, blocked passages. The pollution air flowing through its passage in the TOBI is swirled so that the pollution air that intermingles with the swirled discharge air to reduce the impact to the cooling air temperature on-board the rotor.

Accordingly, the present invention provides a system and method for handling the pollution air such that it minimizes the decrease in velocity of the discharge air used to cool the turbine rotor.

These and other features of the present invention can be best understood from the following specification and drawings, the following of which is a brief description.

### BRIEF DESCRIPTION OF THE DRAWINGS

FIG. 1 is a partial cross-sectional view of a high pressure compressor and first stage turbine of a gas turbine engine.

FIG. 2 is an enlarged perspective view of a tangential on-board injector (TOBI) used to distribute discharge air for cooling the turbine.

FIG. 3 is another partially broken perspective view of the TOBI shown in FIG. 2.

FIG. 4 is a schematic view of the flow of discharge and pollution air through the TOBI.

### DETAILED DESCRIPTION OF THE PREFERRED EMBODIMENT

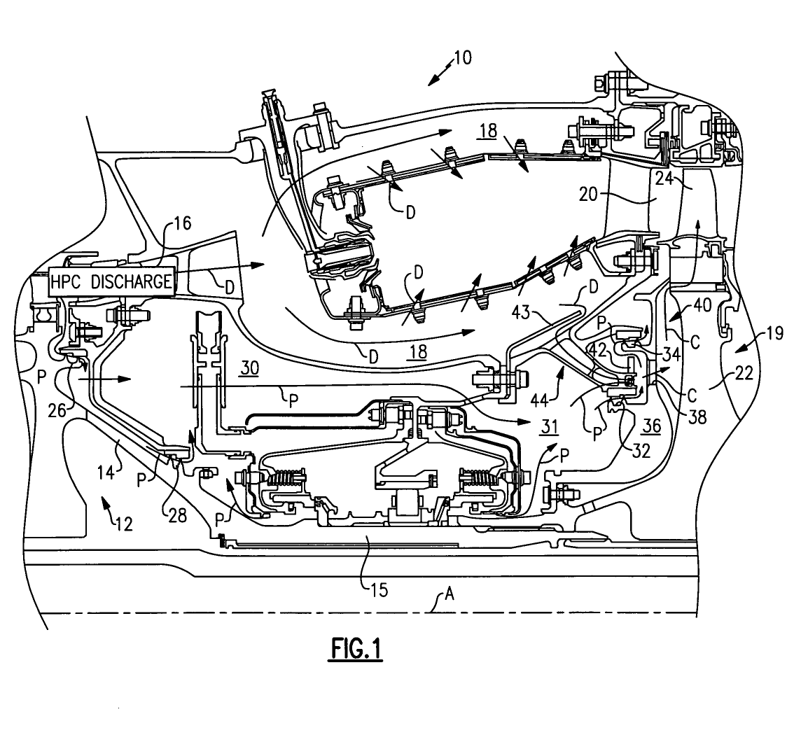

A turbo machine such as a gas turbine engine 10 is shown in FIG. 1. The gas turbine engine 10 includes a compressor 12 and a turbine 19 mounted on a shaft 15, which is rotatable about an axis A. In one example gas turbine engine, the compressor 12 is a high pressure compressor, and a low pressure compressor and fan respectively are located to the left of the compressor 12. The turbine 19 is a high pressure turbine, and a low pressure turbine is located to the right of the turbine 19.

The compressor 12 includes a hub 14 mounted on the shaft 15. A discharge outlet 16 expels discharge air D from the compressor 12 to a turbine inlet 20 via passages 18. A turbine hub 22 supporting blades 24 is mounted on the shaft 15. The blades 24 receive and expand the discharge air D from the turbine inlet 20.

Pollution air P is produced within the gas turbine engine 10 from fluid that leaks past various seals. For example, compressor seals 26 and 28 arranged between the hub 14 and engine housing leak pollution air P into cavities 30 and 31. The pollution air P then leaks past seal 32 and reaches the turbine 19.

A nozzle such as a tangential on-board injector (TOBI) 44 delivers discharge air D to a space 40 near the turbine 16 for cooling the turbine hub 22. In the example shown, a baffle 43 is arranged between the passage 18 and the TOBI 44 to force the air to turn abruptly to separate debris before reaching the turbine 19. A member 36 separates the TOBI 44 and the turbine hub 22, and an aperture 38 is provided in the member 36 to permit cooling air C from the TOBI 44 to reach the turbine 19.

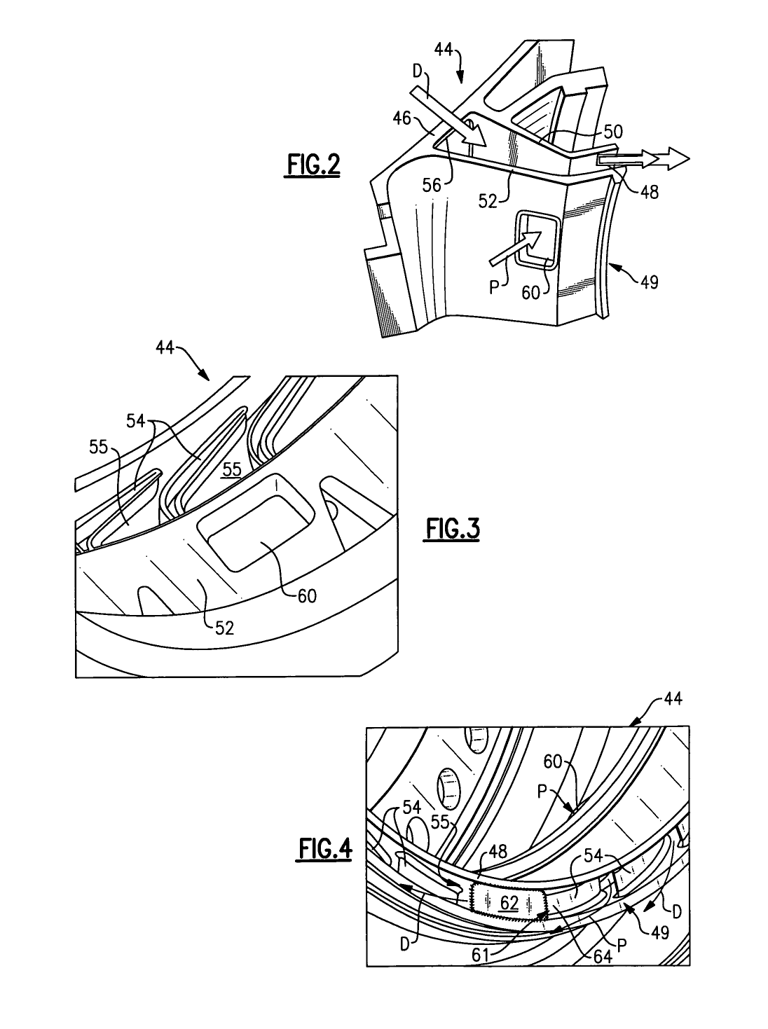

One example of TOBI 44 includes a hollow frustoconical-shaped manifold provided by first, second, third and fourth walls 46, 48, 50 and 52. Various views of the example embodiment 44 are shown in FIGS. 2-4. Vanes 54 are arranged within the cavity provided by the walls 46, 48, 50 and 52 to swirl the discharge air D prior to reaching the rotor 19 to provide more efficient cooling, as is known in the art. The vanes 54 provide multiple passages 55. Many of the passages 55 do not carry discharge or pollution air D, P. TOBIs are typically designed so that fluid inlets and outlets can be provided in the TOBI at a later time having a desired size to provide a desired amount of discharge air to the turbine. The TOBIs 44 are typically cast with the passages 55 open at the second wall 48 to provide holes 64. The holes 64 are sized to achieve desired flow through the TOBI 44 for various applications. The holes 64 are then blocked, as shown at 62, to obtain the desired flow for the particular application.

Previously, the low momentum pollution air P simply leaked past the seal 32 and inhibited the flow of the discharge air D from the TOBI, which raised the pressure of the discharge air thereby reducing its cooling effectiveness. Typically, a discharge inlet 56 is provided in the first wall 46 near the outer diameter of the TOBI 44. A discharge outlet 58 is provided on the second wall 48, which is arranged on a side 49 facing the turbine hub 22 and is generally annular in shape. The example embodiment utilizes the passages 55 that would otherwise be blocked and unused. One or more pollution inlets 60 are provided on the inner or fourth wall 52 of the TOBI 44. The pollution inlets 60 are exposed to the cavity 31 so that pollution air P flows thru the TOBI 44 rather than leaking past the seal 32. Pollution outlets 61 are formed on the side 49 in the second wall 48. In this manner, pollution air P received by pollution inlets 60 is swirled in the same manner as the discharge air D and intermingled with the discharge air D when the pollution air P exits the pollution outlet 61.

An annular discourager 42 is mounted on a circumference of the TOBI 44 and extends radially outward. The discourager 42 prevents cooling air C from leaking past a seal 34 between the TOBI 44 and turbine 19.

TOBIs 44 can be retrofitted with the feature described in the present application by machining the existing TOBI and welding in pollution inlets and outlets 60 and 61 as described.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A gas turbine engine comprising:
a turbine rotor;
a compressor providing discharge air; and
an on-board injector that delivers the discharge air near the turbine rotor for cooling the turbine rotor, the on-board injector receiving pollution air leaking past seals within the gas turbine engine and introducing the pollution air to the discharge air.

2. The gas turbine engine according to claim 1, wherein the on-board injector includes a pollution inlet provided on an inner surface of the on-board injector, and a pollution outlet on a side of the on-board injector nearest the turbine rotor.

3. The gas turbine engine according to claim 2, wherein the on-board injector includes a discharge air outlet on the side of the on-board injector nearest the turbine rotor, and a discharge air inlet opposite the discharge air outlet.

4. The gas turbine engine according to claim 3, wherein the on-board injector has a generally frustoconical shape.

5. The gas turbine engine according to claim 1, wherein the on-board injector includes passages separated by vanes for swirling the discharge and pollution air.

6. The gas turbine engine according to claim 5, wherein the on-board injector includes a discourager extending radially outwardly from a circumference of the on-board injector near the turbine rotor.

7. The gas turbine engine according to claim 5, comprising first and second seals arranged between the on-board injector and the turbine rotor and a second seal arranged between the housing and the turbine rotor, the discourager arranged between the first and second seals to inhibit flow of discharge and pollution air from the first seal to the second seal.

8. The gas turbine engine according to claim 7, wherein the discourager is annular in shape.

9. A method of managing pollution air within a turbo machine comprising the steps of:
a) swirling pollution air;
b) introducing the swirled pollution air to discharge air; and
c) cooling a turbine rotor with the discharge air and swirled pollution air.

10. The method according to claim 9, wherein the discharge air is swirled, and step c) includes cooling the turbine rotor with the swirled discharge air.

11. The method according to claim 10, comprising step d) inhibiting a flow of cooling air from flowing past a seal arranged between a turbine rotor and an on-board injector carrying the swirled pollution air and swirled discharge air.

12. The method according to claim 10, wherein step c) includes mixing the pollution air and discharge air prior to cooling the turbine rotor.

13. A method of manufacturing a turbo machine comprising the steps of:
a) providing a structure having multiple passages separated from one another and near a turbine rotor;
b) providing discharge inlets and outlets in communication with at least some of the multiple passages; and
c) creating at least one pollution inlet and outlet in at least one of the multiple passages different than at some of the multiple passages, the pollution inlet located on a different side than the discharge inlets.

14. The method according to claim 13, wherein step b) includes machining the discharge inlets and outlets to a desired size.

15. The method according to claim 13, wherein step c) includes machining the pollution inlet on an inner wall of the structure.

16. The method according to claim 13, comprising step b) mounting a discourager on an outer surface of the structure.
